(19) United States
(12) Patent Application Publication
(10) Pub. No.: US 2019/0084150 A1
(43) Pub. Date: Mar. 21, 2019

(54) ROBOT, SYSTEM, AND METHOD WITH CONFIGURABLE SERVICE CONTENTS

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XUE-QIN ZHANG, Shenzhen (CN)

(21) Appl. No.: 15/854,686

(22) Filed: Dec. 26, 2017

(30) Foreign Application Priority Data
Sep. 21, 2017 (CN) 201710861591.5

(51) Int. Cl. B25J 9/16; B25J 11/00

(52) U.S. Cl. CPC B25J 9/161; B25J 9/0003; B25J 11/0045

(57) ABSTRACT

A robot with configurable service contents is disclosed, whereby at least one editing interface to edit service content of the robot is provided, for a user to test and input instructions to the robot which can then utilize and act upon such instructions in carrying out tasks. A method with configurable service contents in the robot is also provided.

### CROSS-REFERENCE TO RELATED APPLICATIONS

This application claims priority to Chinese Patent Application No. 201710861591.5 filed on Sep. 21, 2017, the contents of which are incorporated by reference herein.

### FIELD

The subject matter herein generally relates to data processing field, and particularly, to a robot, a system, and a method with configurable service contents.

### BACKGROUND

In prior art, robot's hardware, software, and service content are bound up with each other, which is inconvenient to modify or change the robot's software and service content for a prototyping robot. Thus, the robot is largely inflexible.

### BRIEF DESCRIPTION OF THE DRAWINGS

Implementations of the present disclosure will now be described, by way of example only, with reference to the attached figures.

FIG. 1 is a block diagram of one embodiment of a running environment of a system with configurable service contents.

FIG. 2 is a block diagram of one embodiment of a robot with configurable service contents.

FIG. 3 is a schematic diagram of one embodiment of the robot of FIG. 2.

FIG. 4 is a block diagram of one embodiment of the system of FIG. 1.

FIG. 5 is a schematic diagram of one embodiment of an editing interface in the system of FIG. 1.

FIG. 6 is a schematic diagram of one embodiment of a relationship table in the system of FIG. 1.

FIG. 7 is a flowchart of one embodiment of a method with configurable service contents.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

Exemplary embodiments of the present disclosure will be described in relation to the accompanying drawings.

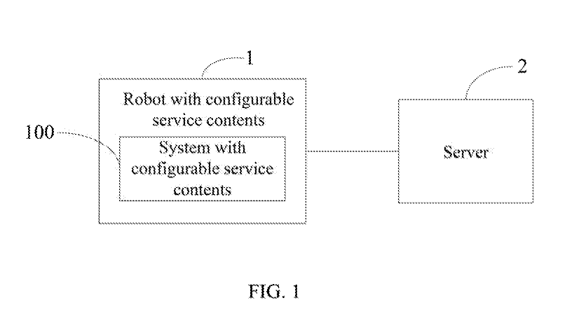

FIG. 1 illustrates a running environment of a system 100 with configurable service contents. The system 100 is run in a robot 1 with configurable service contents. The robot 1 communicates with a server 2. The system 100 is used to edit service content of the robot 1 and control the robot to execute a function corresponding to the edited service content. In at least one exemplary embodiment, the service content includes, but is not limited to screen display content, motion control content, voice dialogue content, and position and navigation content.

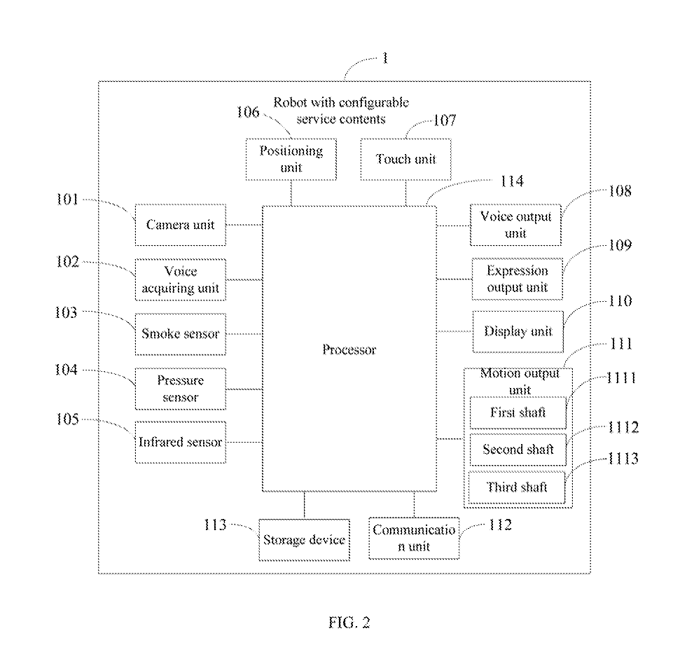

FIG. 2 illustrates the robot 1 with configurable service contents. In at least one exemplary embodiment, the robot 1 includes, but is not limited to, a camera unit 101, a voice acquiring unit 102, a smoke sensor 103, a pressure sensor 104, an infrared sensor 105, a positioning unit 106, a touch unit 107, a voice output unit 108, an expression output unit 109, a display unit 110, a motion output unit 111, a communication unit 112, a storage device 113, and a processor 114. The camera unit 101 is used to shoot an image around the robot 1 and transmit the image to the processor 114. For example, the camera unit 101 shoots a user's face image around the robot 1 and transmits the image to the processor 114. In at least one exemplary embodiment, the camera unit 101 can be a camera. The voice acquiring unit 102 is used to acquire voice message around the robot 1 and transmit the voice message to the processor 114. In at least one exemplary embodiment, the voice acquiring unit 102 can be a microphone array. The smoke sensor 103 is used to acquire information about the atmosphere around the robot 1 and transmit the information to the processor 114.

The pressure sensor 104 is used to detect pressure information of the robot 1 when a user presses the robot 1 and transmit the pressure information to the processor 114. The infrared sensor 105 is used to detect temperature information around the robot 1 and transmit the information to the processor 114. The positioning unit 106 is used to acquire position information of the robot 1 and transmit the position information of the robot 1 to the processor 114. The touch unit 107 is used to receive touch information of the robot 1 and transmit the touch information to the processor 114. In at least one exemplary embodiment, the touch unit 107 can be a touch screen.

The voice output unit 108 is used to output voice information under control of the processor 114. In at least one exemplary embodiment, the voice output unit 108 can be a loudspeaker 108. The expression output unit 109 is used to output visual and vocal expressions under the control of the processor 114. In at least one exemplary embodiment, the expression output unit 109 includes an eye and a mouth. The eye and the mouth can be opened or closed. The expression output unit 109 controls the eye or the mouth to open and close under the control of the processor 114. The display unit 110 is used to display information of the robot 1 under control of the processor 114. For example the display unit 110 can display word, picture, or video information under the control of the processor 114. In another embodiment, the display unit 110 is used to display an image of an expression. For example, the expression image can be a happiness, misery, or other expression of mood. In at least one exemplary embodiment, the touch unit 107 and the display unit 110 can be a touch screen.

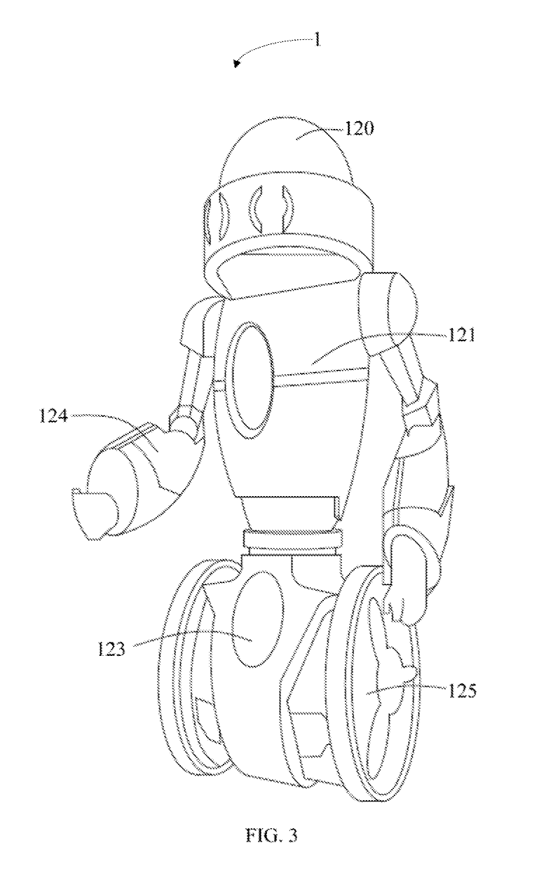

The motion output unit 111 controls the robot 1 to move under the control of the robot 1. In at least one exemplary embodiment, the motion output unit 111 includes a first shaft 1111, two second shafts 1112, and a third shaft 1113. FIG. 3 illustrates a schematic diagram of the robot 1. The robot 1 includes a head 120, an upper trunk 121, a down trunk 123, a couple arms 124, and a wheelpair 125. The upper trunk 121 connects to the head 120 and the down trunk 123. The couple of arms 124 connect to the upper trunk 121. The wheelpair 125 connects to the down trunk 123. The first shaft 1111 connects to the head 120. The first shaft 1111 is able to drive the head 120 to rotate. One of the couple of the arms 124 connects to the upper trunk 121 through one second shaft 1112. The second shaft 1112 is able to drive one arm 124 corresponding to second shaft 1112 to rotate. The two ends of the third shaft 1113 connect to the wheelpair 125. The third shaft 1113 is able to rotate the wheelpair 125, thus making the robot 1 move.

The robot 1 communicates with the server 2. In at least one exemplary embodiment, the communication unit 112 can be a WIFI communication module, a ZIGBEE communication module, or a BLUETOOTH module. In another embodiment, the robot 1 can communicate with a household appliance through the communication unit 112. For example, the household appliance can be an air conditioning, a light, or a TV, and the communication unit 112 can be an infrared communication module.

The storage device 113 stores data and program of the robot 1. For example, the storage device 113 can store the system 100 with configurable service contents, preset face images, and preset voices. In at least one exemplary embodiment, the storage device 113 can include various types of non-transitory computer-readable storage mediums. For example, the storage device 113 can be an internal storage system of the robot 1, such as a flash memory, a random access memory (RAM) for temporary storage of information, and/or a read-only memory (ROM) for permanent storage of information. The storage device 113 can also be an external storage system, such as a hard disk, a storage card, or a data storage medium. In at least one exemplary embodiment, the processor 114 can be a central processing unit (CPU), a microprocessor, or other data processor chip that performs functions of the system 100 with configurable service contents.

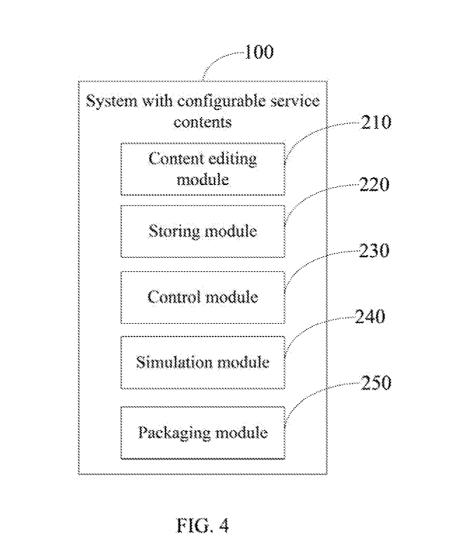

FIG. 4 illustrates the system 100 with configurable service contents. In at least one exemplary embodiment, the system 100 includes, but is not limited to, a content editing module 210, a storing module 220, and a control module 230. The modules 210-230 of the system 100 can be collections of software instructions. In at least one exemplary embodiment, the software instructions of the content editing module 210, the storing module 220, and the control module 230 are stored in the storage device 113 and executed by the processor 114.

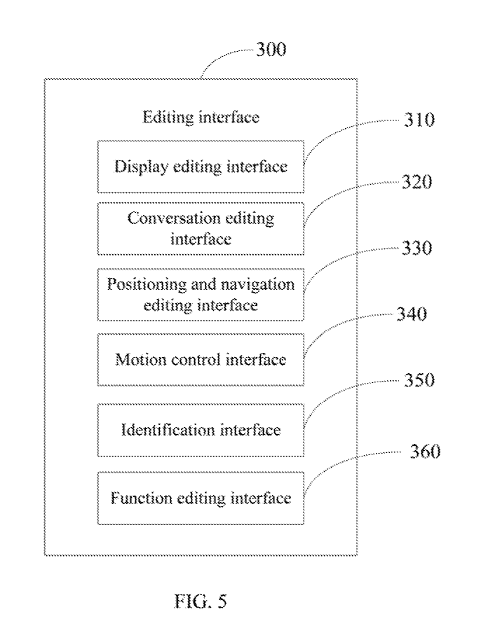

The content editing module 210 provides at least one editing interface 300 to edit service of the robot 1 content for a user. FIG. 5 illustrates the editing interface 300. The editing interface 300 includes a display editing interface 310, a conversation editing interface 320, a positioning and navigation editing interface 330, a motion control interface 340, an identification interface 350, and a function editing interface 360.

The storing module 220 stores the service content edited by the content editing module 210.

The control module 230 controls the robot 1 to execute the service content.

In at least one exemplary embodiment, the content editing module 210 includes a display content editing sub-module 211. The display content editing sub-module 211 provides the display content editing interface 310. The display content editing interface 310 enables a user to edit display content of the robot 1. For example, the user can edit an expression image of the robot 1 through the display content editing interface 310. The expression image can be a smile and blink expression image of the robot 1, a cute expression image of the robot 1, and so on. The expression image can also be the dynamic expression image that expresses happiness, irritability, joy, depression emotion. In another embodiment, the display content editing interface 310 can edit text or video information. The format of the video information includes formats such as SWF, GIF, AVOX, PNG and the like.

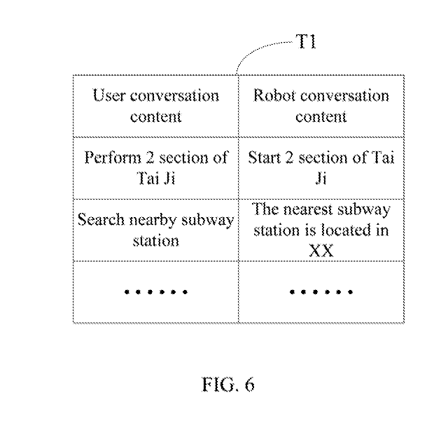

In at least one exemplary embodiment, the content editing module 210 includes a conversation content editing sub-module 212. The conversation content editing sub-module 212 provides the conversation editing interface 320. The conversation editing interface 320 enables a user to edit conversation content of the robot 1. In at least one exemplary embodiment, the conversation content of the robot 1 includes user conversation content and robot conversation content. The conversation editing interface 320 acquires user conversation content and robot conversation content through the voice acquiring unit 102, and establishes a relationship T1 (refer to FIG. 6) between the user conversation content and the robot conversation content, thus accomplishing editing conversation content of the robot 1. For example, the user conversation content can be “perform 2 section of Tai Ji”, the corresponding robot conversation content can be the response “start 2 section of Tai Ji”. For example, the user conversation content can be “search for nearest subway station”, the corresponding robot conversation content can be the response “the nearest subway station is located in XX”. In at least one exemplary embodiment, the conversation content of the robot 1 can be applied to bank consultation service, child education service, and the like.

In at least one exemplary embodiment, the content editing module 210 includes a positioning and navigation content editing sub-module 213. The positioning and navigation content editing sub-module 213 provides the positioning and navigation editing interface 330. The positioning and navigation editing interface 330 is used to edit positioning and navigation content of the robot 1. In at least one exemplary embodiment, the positioning and navigation editing interface 330 acquires location of the robot 1 through a positioning unit 106, and marks the acquired location of the robot 1 in an electronic map, thus the robot 1 is positioned. In at least one exemplary embodiment, the electronic map is stored in the storing device 113, the positioning and navigation editing interface 330 acquires the electronic map from the storing device 113. In another embodiment, the electronic map is stored in the server 2, the positioning and navigation editing interface 330 acquires the electronic map from the server 2.

In at least one exemplary embodiment, the positioning and navigation content editing sub-module 213 also acquires a destination location input by the user. For example, the positioning and navigation content editing sub-module 213 acquires the destination location through the voice acquiring unit 102 by acquiring user's voice. The positioning and navigation content editing sub-module 213 can further mark the acquired destination location in the electronic map, and generate a route from the location of the robot 1 to the destination location.

In at least one exemplary embodiment, the content editing module 210 includes a motion control content editing sub-module 214. The motion control content editing sub-module 214 provides the motion control interface 340. The motion control interface 340 enables a user to edit motion control content of the robot 1. In at least one exemplary embodiment, the motion control content of the robot 1 includes controlled object and control parameter corresponding to the controlled object. The controlled object can be the head 120, the couple of arms 124, or the wheelpair 125. The control parameter can be motion parameter corresponding to the head 120, the couple of arms 124, or the wheelpair 125. In at least one exemplary embodiment, the motion parameter corresponding to the head 120 of the robot 1 is a rotation angle, the motion parameter corresponding to the arm 123 of the robot 1 is swinging and swing amplitude, and the motion parameter corresponding to the wheelpair 125 of the robot 1 is number of rotations. The motion control interface 340 controls the first shaft 1111 connected to the head 120 to rotate according to the rotation angle. Thus, the head 120 is controlled to move by the motion control interface 340. The motion control interface 340 controls the second shaft 1112 connected to the arm 123 to swing according to the swing amplitude. Thus, the arm 123 is controlled to move by the motion control interface 340. The motion control interface 340 controls the third shaft 1113 connected to the wheelpair 125 to rotate a certain number of rotations. Thus, the wheelpair 125 is controlled to move by the motion control interface 340.

In at least one exemplary embodiment, a target service content can be edited by the display content editing sub-module 211, the conversation content editing sub-module 212, the positioning and navigation content editing sub-module 213, and the motion control content editing sub-module 214. In at least one exemplary embodiment, the target service content can be meal delivery service content. For example, the display content editing interface 310 provided by the display content editing sub-module 211 can edit a smile and blink expression image of the robot 1. Then, the conversation editing interface 320 provided by the conversation content editing sub-module 212 can edit “delivery meal to first table” as the user conversation content, edits “OK, first table” as the responsive conversation content of the robot, and establishes the edit user conversation content and the conversation content of the robot in the relationship table T1. The navigation editing interface 330 provided by the navigation content editing sub-module 213 acquires the location of the robot 1, and marks the location of the robot 1 in the electronic map. The navigation editing interface 330 further acquires the “first table” as the destination location through the voice acquiring unit 102, and generates a route from the location of the robot 1 to the destination location. Finally, the motion control interface 340 provided by the motion control content editing sub-module 214 rotates the wheelpair 125 of robot 1 to move according to the route.

In at least one exemplary embodiment, the content editing module 210 further includes an identifying content editing sub-module 215. The identifying content editing sub-module 215 provides the identification interface 350. The identification interface 350 enables a user to edit identifying content of the robot 1. In at least one exemplary embodiment, the identifying content of the robot 1 includes human face identification. For example, the identification interface 350 acquires human face image through the camera unit 101, compares the acquired human face image with preset user face images to identify the acquired human face image. In at least one exemplary embodiment, the identifying content of the robot 1 includes human body identification. For example, the identification interface 350 identifies the human body around the robot 1 through the infrared sensor 105. In another embodiment, the identifying content of the robot 1 includes smoke identification. For example, the identification interface 350 identifies smoke around the robot 1 through the smoke sensor 103. In other embodiment, the identifying content of the robot 1 includes pressure identification. For example, the identification interface 350 identifies the pressure put on the robot 1 through the pressure sensor 104.

In at least one exemplary embodiment, the content editing module 210 further includes a function content editing sub-module 216. The function content editing sub-module 216 provides the function editing interface 360. The function editing interface 360 enables a user to edit function content of the robot 1. In at least one exemplary embodiment, the function content of the robot 1 includes intelligent home control content. For example, the function editing interface 360 receives a control command input by a user. The control command includes a second controlled object and a control operation corresponding to the second controlled object. In at least one exemplary embodiment, the second controlled object includes, but is not limited to, air conditioner, TV, light, and refrigerator. The control operation includes, but is not limited to, turning on or turning off such device. In at least one exemplary embodiment, the function editing interface 360 receives the control command through the voice acquiring unit 102, sends the control command to the second controlled object included in the control command, and controls the second controlled object according to the control operation included in the control command. Thus, the function editing interface 360 edits the intelligent home control content.

In another embodiment, the function content of the robot 1 includes payment content. For example, the function editing interface 360 communicates with a fee payment center through the communication unit 112. The function editing interface 360 also provides a payment interface to receive the payment amount information and payment verification information input by user, and sends the received the payment amount information and payment verification information to the fee payment center to accomplish payment. Thus, the function editing interface 360 edits the payment content.

In at least one exemplary embodiment, the system with configurable service contents further includes a simulation module 240 and a compiling and packaging module 250. The simulation module 240 is used to simulate the edited service content. The simulation module 240 further provides a simulation interface (not shown) to display the simulation result. The compiling and packaging module 250 is used to compile the edited service content, and package the edited service content to create an application or program.

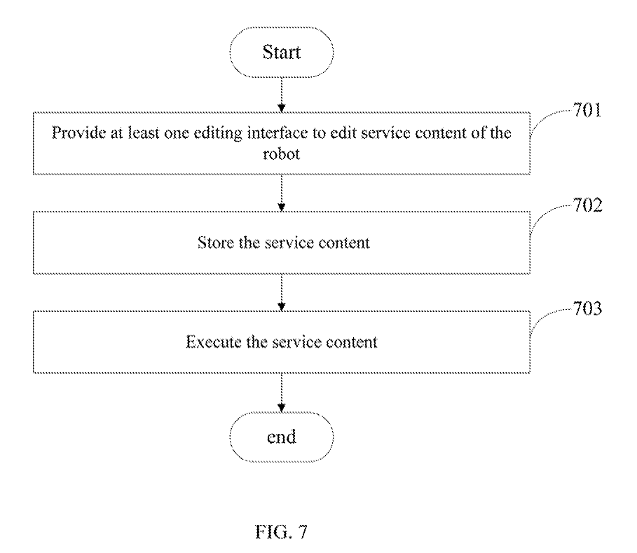

FIG. 7 illustrates a flowchart of one embodiment of a method with configurable service contents. The method is provided by way of example, as there are a variety of ways to carry out the method. The method described below can be carried out using the configurations illustrated in FIGS. 1-6, for example, and various elements of these figures are referenced in explaining the example method. Each block shown in FIG. 7 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 701.

At block 701, a robot provides at least one editing interface to edit service content of the robot for a user. The editing interface includes a display editing interface, a conversation editing interface, a positioning and navigation editing interface, a motion control interface, an identification interface, and a function editing interface.

The robot stores the service content edited by the user.

The robot executes the service content.

In at least one exemplary embodiment, the robot provides the display content editing interface. The display content editing interface enables a user to edit display content of the robot. For example, the user can edit an expression image of the robot through the display content editing interface. The expression image can be a smile and blink expression image of the robot, a cute expression image of the robot, and so on. The expression image can also be the dynamic expression image that expresses the happiness, irritability, joy, depression emotion. In another embodiment, the display content editing interface can edit text or video information. The format of the video information comprises formats such as SWF, GIF, AVOX, PNG and the like.

In at least one exemplary embodiment, the robot provides the conversation editing interface. The conversation editing interface enables a user to edit conversation content of the robot. In at least one exemplary embodiment, the conversation content of the robot includes user conversation content and robot conversation content. The conversation editing interface acquires user conversation content and robot conversation content through the voice acquiring unit, and establishes a relationship (referring to FIG. 6) between the user conversation content and the robot conversation content, thus accomplishing editing conversation content of the robot. For example, the user conversation content can be “perform 2 section of Tai Ji”, the corresponding robot conversation content can be the response “start 2 section of Tai Ji”. For example, the user conversation content can be “search the nearest subway station”, the corresponding robot conversation content can be the response “the nearest subway station is located in XX”. In at least one exemplary embodiment, the conversation content of the robot can be applied to bank consultation service, child education service and the like.

In at least one exemplary embodiment, the robot provides the positioning and navigation editing interface. The positioning and navigation editing interface is used to edit positioning and navigation content of the robot. In at least one exemplary embodiment, the positioning and navigation editing interface acquires location of the robot through a positioning unit, and marks the acquired location of the robot in an electronic map, thus, the robot is positioned. In at least one exemplary embodiment, the electronic map is stored in the storing device, the positioning and navigation editing interface acquires the electronic map from the storing device. In another embodiment, the electronic map is stored in the server, the positioning and navigation editing interface acquires the electronic map from the server 2.

In at least one exemplary embodiment, the robot also acquires a destination location input by the user. For example, the robot acquires the destination location through the voice acquiring unit by acquiring user's voice. The robot further can mark the acquired destination location in the electronic map, and generate a route from the location of the robot to the destination location.

In at least one exemplary embodiment, the robot provides the motion control interface. The motion control interface enables a user to edit motion control content of the robot. In at least one exemplary embodiment, the motion control content of the robot includes a controlled object and a control parameter corresponding to the controlled object. The controlled object can be the head, the couple of arms or the wheelpair. The control parameter can be motion parameter corresponding to the head, the couple of arms or the wheelpair. In at least one exemplary embodiment, the motion parameter corresponding to the head of the robot is rotation angle, the motion parameter corresponding to the arm of the robot is swing amplitude, and the motion parameter corresponding to the wheelpair of the robot is number of rotations. The robot controls the first shaft connected to the head to rotate according to the rotation angle. Thus, the head is controlled to move by the robot. The robot controls the second shaft connected to the arm to swing according to the swing amplitude. Thus, the arm is controlled to move by the robot. The robot 1 controls the third shaft connected to the wheelpair to rotate according to a curtain number of rotations. Thus, the wheelpair is controlled to move by the robot.

In at least one exemplary embodiment, a target service content can be edited by the robot. In at least one exemplary embodiment, the target service content can be a meal delivery service content. For example, the display content editing interface edits a smile and blink expression image of the robot. Then, the conversation editing interface edits “delivery meal to first table” as the user conversation content, edits “OK, first table” as the conversation content of the robot, and establish the edit user conversation content and the conversation content of the robot in the relationship table. The navigation editing interface acquires the location of the robot, and marks the location of the robot in the electronic map. The navigation editing interface further acquires the “first table” as the destination location through the voice acquiring unit, and generates a route from the location of the robot to the destination location. Last, the motion control interface controls the wheelpair of robot to rotate to drive the robot to move according to the route.

In at least one exemplary embodiment, the robot provides the identification interface. The identification interface enables a user to edit identifying content of the robot. In at least one exemplary embodiment, the identifying content of the robot includes human face identification. For example, the identification interface acquires human face image through the camera unit, compares the acquired human face image with a preset user face image to identify the acquired human face image. In at least one exemplary embodiment, the identifying content of the robot includes human body identification. For example, the identification interface identifies the human body around the robot through the infrared sensor. In another embodiment, the identifying content of the robot includes smoke identification. For example, the identification interface identifies smoke around the robot through the smoke sensor. In other embodiment, the identifying content of the robot includes pressure identification. For example, the identification interface identifies the pressure put on the robot through the pressure sensor.

In at least one exemplary embodiment, the robot provides the function editing interface. The function editing interface enables a user to edit function content of the robot. In at least one exemplary embodiment, the function content of the robot includes intelligent home control content. For example, the function editing interface receives a control command input by a user. The control command includes a second controlled object and a control operation corresponding to the second controlled object. In at least one exemplary embodiment, the second controlled object includes, but is not limited to air conditioner, TV, light, refrigerator. The control operation includes, but is not limited to turning on or turning off such device. In at least one exemplary embodiment, the function editing interface receives the control command through the voice acquiring unit, sends the control command to the second controlled object included in the control command, and control the second control object according to the control operation included in the control command. Thus, the function editing interface edits the intelligent home control content.

In another embodiment, the function content of the robot includes payment content. For example, the function editing interface communicates with a fee payment center through the communication unit. The function editing interface also provides a payment interface to receive the payment amount information and payment verification information input by user, and sends the received the payment amount information and payment verification information to the fee payment center to accomplish payment. Thus, the function editing interface edits the payment content.

In at least one exemplary embodiment, the method further includes: simulate the edited service content; and compile the edited service content, and packaging the edited service content to create an application.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A robot with configurable service contents comprising:
a processor;
a non-transitory storage medium coupled to the processor and configured to store a plurality of instructions, which cause the processor to control the robot to:
provide at least one editing interface to edit service content of the robot;
store the service content; and
control the robot to execute the service content.

2. The robot with configurable service contents as recited in claim 1, wherein the editing interface comprises a display editing interface, a conversation editing interface, a positioning and navigation editing interface, and a motion control interface, the display content editing interface is configure to edit display content of the robot, the conversation editing interface is configured to edit conversation content of the robot, the positioning and navigation editing interface is configured to edit positioning and navigation content of the robot, the motion control interface is configured to edit motion control content of the robot.

3. The robot with configurable service contents as recited in claim 1, wherein a target service content can be edited by the display editing interface, the conversation editing interface, the positioning and navigation editing interface, and the motion control interface, wherein the target service comprises meal delivery service content.

4. The robot with configurable service contents as recited in claim 1, wherein the editing interface comprises an identification interface, the identification interface is configured to edit identifying content of the robot, wherein the identifying content of the robot comprises human face identification.

5. The robot with configurable service contents as recited in claim 1, wherein the editing interface comprises a function editing interface, the function editing interface is configured to edit function content of the robot, the function content of the robot comprises intelligent home control content.

6. The robot with configurable service contents as recited in claim 1, wherein the motion control content of the robot comprises a controlled object and a control parameter corresponding to the controlled object, wherein, the controlled object comprises a head of the robot, a couple of arms of the robot or a wheelpair of the robot, the control parameter comprises rotation of the head , swing amplitude of the couple of arms, or number of rotations of the wheelpair.

7. The robot with configurable service contents as recited in claim 1, wherein the plurality of instructions is further configured to cause the processor to editing interface comprises:
simulate the service content.

8. The robot with configurable service contents as recited in claim 1, wherein the plurality of instructions is further configured to cause the processor to editing interface comprises:
compile the edited service content; and
package the edited service content to create an application.

9. A method with configurable service contents comprising:
providing at least one editing interface to edit service content of a robot;
storing the service content; and
controlling the robot to execute the service content.

10. The method with configurable service contents as recited in claim 9, wherein the editing interface comprises a display editing interface, a conversation editing interface, a positioning and navigation editing interface, and a motion control interface, the display content editing interface is configure to edit display content of the robot, the conversation editing interface is configured to edit conversation content of the robot, the positioning and navigation editing interface is configured to edit positioning and navigation content of the robot, the motion control interface is configured to edit motion control content of the robot.

11. The method with configurable service contents as recited in claim 9, wherein a target service content can be edited by the display editing interface, the conversation editing interface, the positioning and navigation editing interface, and the motion control interface, wherein the target service comprises meal delivery service content.

12. The method with configurable service contents as recited in claim 9, wherein the editing interface comprises an identification interface, the identification interface is configured to edit identifying content of the robot, wherein the identifying content of the robot comprises human face identification.

13. The method with configurable service contents as recited in claim 9, wherein the editing interface comprises a function editing interface, the function editing interface is configured to edit function content of the robot, the function content of the robot comprises intelligent home control content.

14. The method with configurable service contents as recited in claim 9, further comprising:
simulating the service content;
compiling the edited service content; and
packaging the edited service content to create an application.

15. A non-transitory storage medium having stored thereon instructions that, when executed by a processor of a robot with configurable service contents, causes the processor to execute instructions of a method with configurable service contents, the method comprising:
providing at least one editing interface to edit service content of a robot;
storing the service content; and
controlling the robot to execute the service content.

16. The non-transitory storage medium as recited in claim 15, wherein the editing interface comprises a display editing interface, a conversation editing interface, a positioning and navigation editing interface, and a motion control interface, the display content editing interface is configure to edit display content of the robot, the conversation editing interface is configured to edit conversation content of the robot, the positioning and navigation editing interface is configured to edit positioning and navigation content of the robot, the motion control interface is configured to edit motion control content of the robot.

17. The non-transitory storage medium as recited in claim 15, wherein a target service content can be edited by the display editing interface, the conversation editing interface, the positioning and navigation editing interface, and the motion control interface, wherein the target service comprises meal delivery service content.

18. The non-transitory storage medium as recited in claim 15, wherein the editing interface comprises an identification interface, the identification interface is configured to edit identifying content of the robot, wherein the identifying content of the robot comprises human face identification.

19. The non-transitory storage medium as recited in claim 15, wherein the editing interface comprises a function editing interface, the function editing interface is configured to edit function content of the robot, the function content of the robot comprises intelligent home control content.

20. The non-transitory storage medium as recited in claim 15, wherein the method is further comprising:
simulating the service content;
compiling the edited service content; and
packaging the edited service content to create an application.
